(19) United States
(12) Patent Application Publication
(10) Pub. No.: US 2004/0088248 A1
(43) Pub. Date: May 6, 2004

(54) Systems and methods for implementing a grace period in electronic transfers

(75) Inventor: Justine Cutler, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO

(21) Appl. No.: 10/397,041

(22) Filed: Mar. 24, 2003

Related U.S. Application Data
(60) Provisional application No. 60/423,518, filed on Nov. 4, 2002.

(51) Int. Cl. G06F 17/60

(52) U.S. Cl. 705/38; 705/40

(57) ABSTRACT

A method of facilitating the repayment of a loan to a creditor includes receiving a request from a customer to initiate loan acceleration. On about the last day of a grace period relating to a loan payment of the customer, an electronic funds transfer to pay the loan payment is processed. Prior to the end of the grace period, information is sent to the creditor that credits the customer for having paid the loan. A first amount is debited from an account of the customer. Contemporaneously with a payday of the customer, a second amount is debited from an account of the customer. The second amount is debited prior to the end of a subsequent grace period relating to a subsequent loan payment of the loan.

### CROSS-REFERENCES TO RELATED APPLICATIONS

This application is a non-provisional of and claims priority to co-pending, commonly assigned U.S. Provisional Patent Application No. 60/423,518, entitled, “SYSTEMS AND METHODS FOR IMPLEMENTING A GRACE PERIOD IN ELECTRONIC TRANSFERS,” filed on Nov. 4, 2002, which application is incorporated herein by reference in its entirety for all purposes. This application is related to co-pending, commonly assigned U.S. patent application Ser. No. 10/168,871, entitled, “METHOD AND APPARATUS FOR MAPPING SOURCES AND USES OF CONSUMER FUNDS,” filed on Jun. 24, 2002, and to co-pending, commonly assigned U.S. patent application Ser. No. 10/336,671, entitled, “METHODS AND APPARATUS FOR MAPPING SOURCES AND USES OF CONSUMER FUNDS,” filed on Jan. 2, 2003, and to co-pending, commonly assigned U.S. patent application Ser. No. 10/373,578, entitled, “SYSTEMS AND METHODS FOR DIRECTING RECURRING FINANCIAL TRANSFER OPERATIONS,” filed on Feb. 24, 2003, and to co-pending, commonly assigned U.S. patent application Ser. No. 10/302,762, entitled, “SYSTEMS AND METHODS FOR CUSTOMIZING MORTGAGE CHARACTERISTICS,” filed on Nov. 22, 2002, which applications are incorporated herein by reference in their entirety for all purposes.

### BACKGROUND OF THE INVENTION

This invention relates to the field of financial transactions. More specifically, this invention relates to systems and methods for accelerating the repayment of consumer loans.

Most homeowners know that mortgage payments in the early stages of a mortgage make very small reductions in the principal balance since most of these early-year payments represent accrued interest. However, fewer homeowners realize that making even small additional principal payments may reduce their mortgage term by years. For example, a 30-year, $150,000 mortgage at 8% annual interest requires a monthly payment of $1100, principal and interest. Only $1200 of the $13,200 paid during the first year reduces the principal balance. Making only one additional payment per year, however, reduces the mortgage term by more than 7 years, thus turning a 30-year mortgage into a 22.5-year mortgage. The same principle applies to other amortized loans, such as auto loans, although the difference is not so dramatic for loans having smaller balances or lower interest rates.

Many mortgage companies, and even some third-party financial service providers (hereinafter “service provider”), offer services that assist debtors to “accelerate” loan payback periods. An example of such a service is that provided by Paymap, Inc. of San Francisco, Calif., a subsidiary of First Data Corporation. Such services are geared particularly to debtors on a bi-weekly or weekly pay schedule. Since weekly and bi-weekly earners receive 52 and 26 paychecks per year, respectively, (instead of 12 or 24 for monthly and semimonthly earners, respectively) they have the opportunity to make at least one additional loan or mortgage payment annually without experiencing cash flow variations. Other debtors on different pay schedules, however, also may avail themselves of mortgage acceleration by adding an additional amount to each loan payment that represents an additional credit toward principal.

Despite the availability of such services, many debtors cannot or do not take advantage of mortgage or loan acceleration for various reasons. For example, many debtors live paycheck-to-paycheck. Since a mortgage or loan payment may represent a significant portion of their paycheck, it becomes nearly impossible for these debtors to accelerate a payment to an earlier pay period. Further, many paycheck-to-paycheck debtors even pay their mortgage payments after the due date, taking advantage of the grace period (typically fifteen days after the payment is due), which further complicates efforts to get ahead.

It has been reported that debtors who pay loan payments late in the grace period—and especially those that pay after the grace period—are reluctant to avail themselves of loan repayment acceleration programs, perhaps for the reasons stated above. Further, it also has been reported that those late payers who do initiate loan acceleration services often terminate the service during a “transition period” due to cash flow pressures. Thus, systems and methods are needed that allow a greater number of debtors to participate in loan acceleration programs.

### BRIEF SUMMARY OF THE INVENTION

Embodiments of the present invention thus provide a method of facilitating the repayment of a loan to a creditor. The method includes receiving a request from a customer to initiate loan acceleration, and on about the last day of a grace period relating to a loan payment of the customer, processing an electronic funds transfer to pay the loan payment. Prior to the end of the grace period, information is sent to the creditor that credits the customer for having paid the loan. The method also includes debiting a first amount from an account of the customer and contemporaneously with a payday of the customer, debiting a second amount from an account of the customer. The second amount is debited prior to the end of a subsequent grace period relating to a subsequent loan payment of the loan. The method may include, contemporaneously with later paydays of the customer, debiting additional amounts from one or more accounts of the customer and processing additional electronic funds transfers to pay additional loan payments of the customer, such that at some point, consecutive debits from the one or more accounts of the customer occur without an intervening loan payment. The method also may include contemporaneously with later paydays of the customer, debiting additional amounts from one or more accounts of the customer and processing additional electronic funds transfers to pay additional loan payments of the customer, such that at some point, consecutive electronic funds transfers are processed to pay the customer's loan payment without an intervening debit from an account of the customer. An immediately previous loan payment may have been paid by the customer after a grace period relating to the immediately previous payment. The first amount may be less than, approximately 50% of, or greater than 50% of the loan payment. The customer may receive a paycheck on a bi-weekly, weekly, schedule semimonthly, or monthly schedule. The loan may relate to a mortgage.

In other embodiments, a system for facilitating the repayment of a loan to a creditor includes a host computer system that is programmed to process an electronic funds transfer to pay a loan payment of the customer on about the last day of a grace period relating to the loan payment of the customer. The host computer system is also programmed to, prior to the end of the grace period, send information to the creditor that credits the customer for having paid the loan and initiate processing of a debit of a first amount from an account of the customer. The host computer system is also programmed to, contemporaneously with a payday of the customer, initiate processing of a debit of a second amount from an account of the customer. The second amount may be debited prior to the end of a subsequent grace period relating to a subsequent loan payment of the loan. The host computing system also may be programmed to, contemporaneously with later paydays of the customer, debit additional amounts from one or more accounts of the customer and process additional electronic funds transfers to pay additional loan payments of the customer, such that at some point, consecutive debits from the one or more accounts of the customer occur without an intervening loan payment. The host computing system may be programmed such that, contemporaneously with later paydays of the customer, additional amounts are debited from one ore more accounts of the customer and additional electronic funds transfers are processed to pay additional loan payments of the customer, such that at some point, consecutive electronic funds transfers are processed to pay the customer's loan payment without an intervening debit from an account of the customer.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components.

FIG. 1 illustrates an equity acceleration timeline for an earner who receives a paycheck on a semimonthly schedule.

FIG. 2 illustrates an equity acceleration timeline for an earner who receives a paycheck on a biweekly schedule.

FIG. 3 illustrates a method of accelerating the repayment of a loan, according to embodiments of the present invention.

FIG. 4 is a schematic diagram of a system for accelerating the repayment of a loan according to embodiments of the present invention.

### DETAILED DESCRIPTION OF THE INVENTION

The present invention thus provides systems and methods for assisting late payers to avail themselves of loan acceleration programs. For purposes of this description, “late payer” will refer to a debtor who makes loan payments either late in a grace period or after the expiration of the grace period.

Loan acceleration programs are known. For example, previously-incorporated U.S. patent application Ser. No. 10/168,871, provides a detailed description of loan repayment acceleration. For late payers, however, loan repayment acceleration is often unmanageable due to cash flow pressures. According to the present invention, a loan acceleration service provider may gradually transition a late-paying customer into loan acceleration. The process may depend on the customer's payroll income schedule and the degree to which the customer pays his mortgage late. In general, the service provider customizes the amount and timing of withdrawals from the customer's account and the timing of payments to the customer's creditor. In some embodiments, the service provider utilizes an “instantaneous payment” process to effect money transfers in relatively short periods of time. In some embodiments, the service provider also makes payments “at-risk,” meaning making a payment on behalf of a customer prior to having “good” funds from the customer to make the payment, effectually extending the customer's grace period.

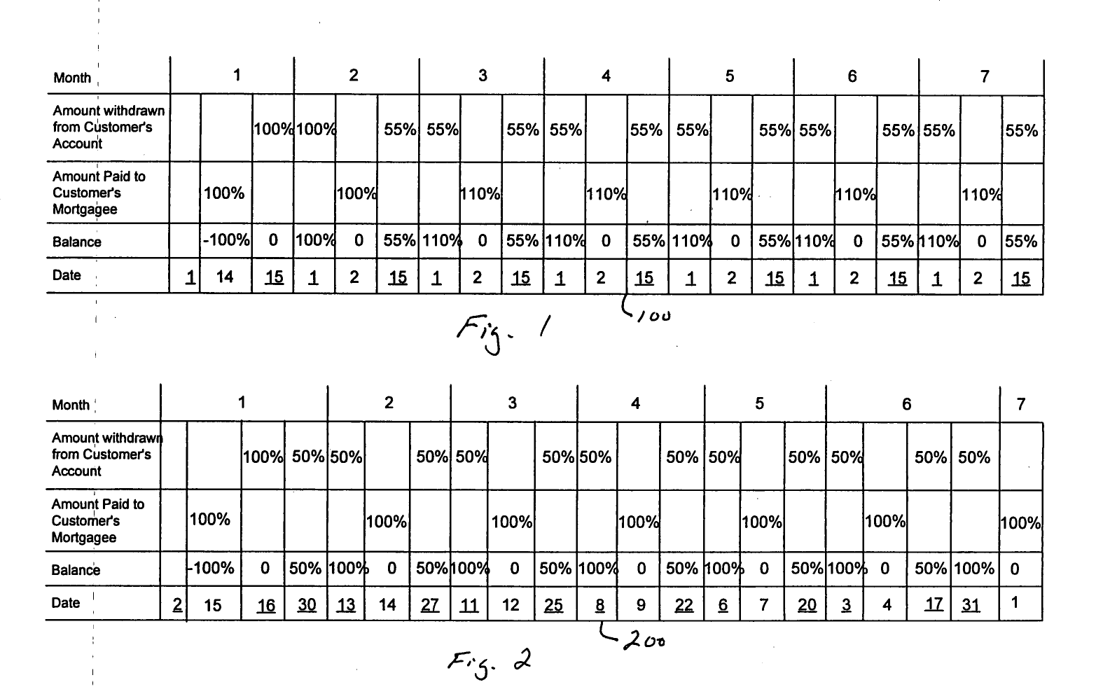

Attention is first directed to FIG. 1, which illustrates a time line 100 depicting a first embodiment according to the present invention. The time line 100 illustrates a period of seven months over which a customer is transitioned into loan acceleration. According to this example, a customer on a semimonthly pay schedule desires to begin paying an additional 10% per month toward his mortgage payment. The customer is paid on the first and the fifteenth of each month, as indicated by the underlines on the date line. The customer's mortgage payment is due on the first of each month and is delinquent after the fifteenth of the month. Thus, the period from the first of the month to the fifteenth of the month is a “grace period.” In this example, the customer is a chronic late payer; he typically pays his mortgage on or after the fifteenth of each month. Thus, heretofore, this customer has been unable to participate in loan acceleration services since his paycheck is completely consumed by his mortgage payment, and because presently-available loan acceleration services required confirmed receipt of funds (i.e., “good funds”) in full prior to making a first payment. Further, presently-available loan acceleration services do not include an instantaneous payment option as provided by the present invention.

Herein, “instantaneous payment” refers to a payer-approved money transfer, typically performed electronically. This capability allows the payer to receive credit for a payment to a creditor on the day the funds are withdrawn from the payer's bank account, or in some cases, the day before the funds are withdrawn. Such payments may be processed immediately, or scheduled for a future date. The process of debiting the payer's account may begin the day the payer's loan account is credited, and the completion of the funds transfer typically occurs the next business day. If the debit transaction is returned (i.e., rejected by the payer's bank), the posting transaction to the payer's account may be reversed, and the funds returned to the payment processor. Regulations may require, for example, that each such transactions be individually approved and that the payer be notified of the completion of each transaction. Instantaneous payment systems are more fully described in co-pending, commonly assigned U.S. Provisional Patent Application No. 60/423,698, filed on Nov. 4, 2002, which application is incorporated herein by reference in its entirety, for all purposes.

According to this example, contemporaneously with the customer's pay date on the fifteenth day of the first month (in this case on the fourteenth of the first month), the service provider processes an instantaneous payment on behalf of the customer. This allows the customer the opportunity to participate in the loan acceleration program without falling further behind with his lender. However, because the service provider has not yet received “good funds” sufficient to pay the customer's entire mortgage payment, the service provider's funds are at risk. However, the service provider may mitigate the risk by, for example, making the payment to the creditor with the understanding that the service provider can reclaim the funds if the customer does not pay. Thus, the customer begins the loan acceleration process by being credited with a payment in full on or before the expiration of the customer's grace period.

A withdrawal contemporaneous with a customer's pay day may be made on the day of the customer's pay day, or within 1-3 business days after the customer's pay day. In some embodiments, the cotemporaneous withdrawal may be made a day before the customers pay day.

In the second month, the service provider once again withdraws a full loan payment from the customer's account contemporaneously with the customer's payday on the first of the month. Subsequent withdrawals from the customer's bank account may occur contemporaneously with the customer's paydays. The amounts withdrawn may be greater than 50% of the customer's loan payment. This allows the customer to gradually begin accelerating his loan repayment. These subsequent payments may be made, to the extent necessary, using the instantaneous payment system.

Continuing with the example of FIG. 1, the service provider continues to withdraw an amount equal to 55% of a mortgage payment from the customer's bank account on the first and the fifteenth of each month. The service provider also processes an electronic payment to pay the customer's mortgage payment once sufficient funds have been withdrawn to cover a payment, in this case on the second day of each month beginning in month two. Beginning in the second month, the service provider may complete the payment via a non-instantaneous payment processing system. Such systems may process payments at a lower cost. Of course, the present invention may include continuing to process payments and/or withdrawals through instantaneous payment processes, as necessary.

Of course, other scenarios for initiating loan acceleration with a semimonthly payroll customer are possible. For example, the customer may make a partial loan payment into a loan acceleration account on the first of the first month, followed by a second payment on the fifteenth of the first month. Each of these payments may equal 55% of the customer's loan payment. This process may continue until the customer has accumulated a sufficient credit balance to begin making extra payments to his mortgage. In this example, multiple payments may be made to the creditor using the instantaneous payment process. Many other examples are possible.

The example of FIG. 1 is intended to be illustrative and not limiting. Many other possibilities exist. For example, the customer may pay more or less than an additional 10% each month. Further, this example does not include compensation to the service provider, which may come from the customer and/or the creditor, for example. Moreover, the present invention may be applied to loans other than mortgage loans. Further still, the present invention may apply to customers having different compensation cycles and/or loan amortization schedules. A second example follows.

Attention is directed to FIG. 2, which illustrates a second timeline 200 for accelerating the repayment of a loan according to the present invention. In the example of FIG. 2, the customer is paid biweekly and has a mortgage with payments due on the first of each month and a 15-day grace period. The customer in this example also is a chronic late payer; however, the customer's lateness is variable since the customer's paycheck frequency is different from the frequency of his mortgage payments. In this example, the customer desires to accelerate his loan repayment by making a thirteenth mortgage payment each year.

In the first month, the service provider debits a full loan payment from the customer's bank account contemporaneously with the payer's payday on the sixteenth of the first month and pays the customer's mortgage payment for the first month on or before the fifteenth of the month, potentially at risk. However, as explained above with respect to FIG. 1, the service provider reduces its risk by making the mortgage payment using an instantaneous payment process. Thus, the service provider is at risk only until the debit made on the sixteenth of the first month clears. If the debit clears before the loan payment is made on the fifteenth, then the service provider is not at risk. Also in the first month, the service provider debits half of a mortgage payment from the customer's bank account on the 30th of the first month, the customer's third payday in the month. Thereafter, the service provider withdraws an amount equal to half a loan payment on each of the customer's paydays.

In the second month, the service provider makes the customer's mortgage payment on time on the fourteenth of the second month and without risk since the service provider collected from the customer on the 30th of the first month and the thirteenth of the second month. However, an instantaneous payment process also may be used in the second month to the extent necessary.

Beginning in the third month, the service provider has collected sufficient funds from the customer by the end of the grace period to make the customer's mortgage payment in the third and subsequent months via a conventional payment processing system. Thereafter, the service provider continues to make additional payments shortly after receiving a second consecutive partial payment from the customer. Thus, by the seventh month, the service provider is making the customer's payment fourteen days sooner, in relation to the payment due date, than the payment was made in the first month. Eventually, the service provider makes a thirteenth payment within a twelve-month period on behalf of the customer, thereby accelerating the customer's loan repayment. Many other scenarios for accelerating loan payments on behalf of customers according to the present invention are possible. For example, the customer may be on a weekly pay schedule, in which case the service provider may withdraw funds from the customer's account weekly. Or the customer may be on a monthly pay schedule, in which case the service provider may withdraw funds monthly. Other possibilities exist.

In some embodiments, the grace period ends on the tenth of the month, instead of the fifteenth. In yet other embodiments, the grace period ends on another day. In some of the previously-described embodiments, the service provider does not make loan payments on behalf of the customer until the service provider receives sufficient funds to pay the customer's loan payment. In such cases, the customer may utilize an instantaneous payment system to provide the customer with the longest grace period possible, thus allowing more customers to participate in loan acceleration than would be able to under heretofore typical circumstances.

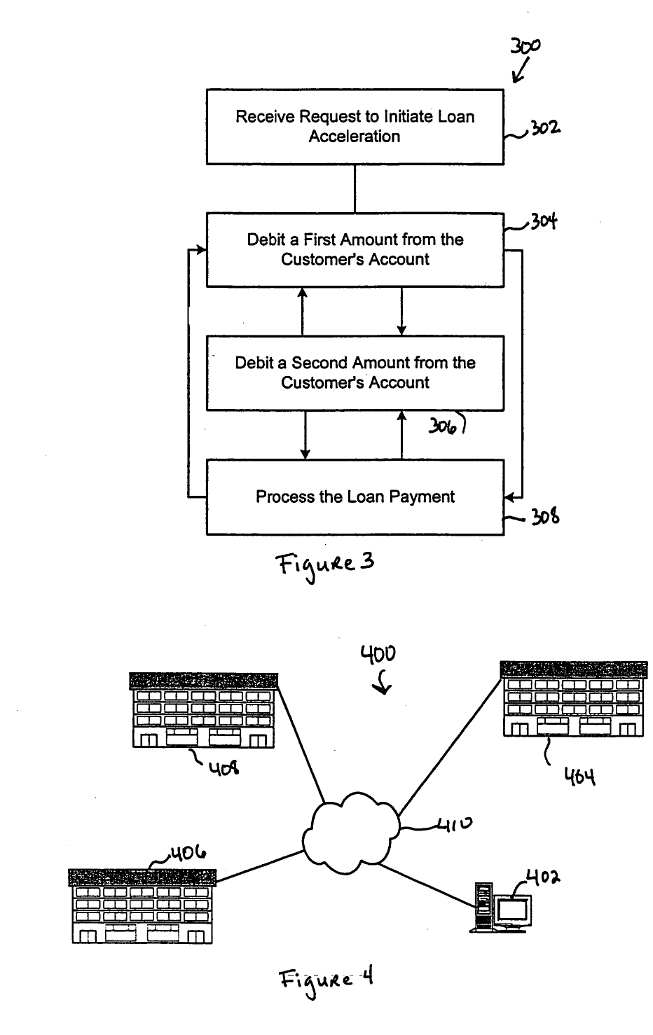

Having described two examples of accelerating loan repayment according to the present invention, attention is directed to FIG. 3, which illustrates a method 300 of facilitating the repayment of a loan according to the present invention. According to this method 300, a loan acceleration service provider receives a request from a customer to accelerate the repayment of a loan at operation 302. The customer may receive his paychecks on a monthly, semimonthly, biweekly, or other schedule. According to this embodiment of the present invention, the customer historically pays his loan near or after the end of the grace period. Thus, the service provider is unable to collect from the customer sufficient good funds to pay the customer's first subsequent mortgage payment.

At operation 304, the service provider collects a first amount from the customer. The first amount may be collected from the customer's checking account, savings account, or other account. The first amount also may be collected from the customer directly, as cash, a money order, or the like. Many other examples are possible. The service provider may use an electronic funds transfer to debit the funds directly from an account owned by the customer. The type of electronic funds transfer may vary, depending on the speed with which the service provider needs the funds. For example, if the service provider needs the funds right away to meet a deadline for making a loan payment, then the service provider may use an instantaneous payment process. Such instantaneous payment processes may have more burdensome regulations, require more frequent approvals from the customer, be more expensive, and the like. However, such processes are useful for quickly transferring funds. In situations when the service provider has time to process transactions through other, potentially less expensive processes, then such processes may be used. The present invention does not require any particular electronic funds transfer system.

At operation 306, the service provider collects a second amount from the customer. The second amount may be either the same amount as or a different amount from the first amount. The amount may be collected in a manner similar to or different from the first amount.

At operation 308, the service provider initiates payment of the customer's loan payment. Operation 308 may take place before or after operation 306. The payment may be on the due date, during the grace period, on the last day of the grace period, or any time prior to the due date. The payment may be through an electronic funds transfer, as discussed above with respect to operation 304. The payment may be the exact amount of the customer's loan payment, or the payment may be a different amount. For example, in some embodiments, the payment at operation 308 is greater than the customer's loan payment in order to facilitate acceleration of the customer's loan repayment. In some embodiments, the loan payment made by the service provider is made before the service provider has collected sufficient good funds from the customer to cover the payment. In other words, the service provider makes the payment “at risk.” Many specific examples are possible and apparent to those skilled in the art in light of this description of the present invention.

The process of collecting funds and making payments may continue, as shown in FIG. 3. It is not, however, necessary that every iteration through operations 304, 306, and 308 be accomplished identically to the immediately prior or any prior iteration. Operations 304, 306, and 308 may be repeated, in any order, for as long as the customer desires to participate in loan acceleration or until the customer's loan is repaid. For example, in some embodiments, operation 308 may take place even before operation 304. The first and second amounts may vary with each iteration through the process or remain the same. In some embodiments, there is a one-to-one correlation between debits from a customer's account and payments to the customer's creditor. In other embodiments, there is a two-to-one correlation. In still other embodiments, there is a four-to-one correlation. Other possibilities exist.

FIG. 4 illustrates a system 400 for facilitating the repayment of a loan, according to the present invention. The system 400 includes a host computer system 402, a creditor financial institution 404, a debtor financial institution 406, a service provider financial institution 408, and a network 410 interconnecting the four. The host computer system 402 may be a single computing device, such as a server or workstation, or a combination of computing deices, storage devices, communication networks, and the like. The host computer system 402 may be a distributed across a large geographic area, or consolidated at a single location. The host computer system 402 includes software that programs it to perform the method of the present invention.

Each of the financial institutions 404, 406, 408, may be a bank, credit union, or the like. Each includes one or more accounts representing funds held on deposit by the account holder. For example, the debtor financial institution 406 may include an account, such as a checking account, through which a homeowner/debtor banks. The account may receive the homeowner's payroll checks and disburse funds to payees upon being presented with checks written by the homeowner and drawn on the account. In some embodiments, the financial institutions are configured to effect transfers to other financial institutions through electronic networks, such as the network 410.

The network 410 may be any one or a combination of telephone networks, optical networks, wired networks, wireless networks, and the like. These networks may include the Internet, Local Area Networks (LANs), Wide Area Networks (WANs), intranets, Virtual Private Networks (VPNs), and the like. In some embodiments, the network 410 comprises at least a portion of the federal funds network, through which money may be transferred among financial institutions. Other possibilities exist.

Thus, as is apparent to those skilled in the art in light of this disclosure, a debtor requests a loan acceleration service provider to initiate loan acceleration for a loan. The debtor banks at the debtor financial institution 406, and the creditor of the loan banks at the creditor financial institution 404. The service provider banks at the service provider financial institution 408 and operates the host computer system 402. The service provider programs the host computer system 402 to initiate electronic funds transfers that draw money from the debtor financial institution 406 and deposit the funds into the service provider financial institution 408. The host computer system 402 is programmed further to transfer funds periodically from the service provider financial institution 408 to the creditor financial institution 404 as payment of the debtor's loan. The timing and amount of the transfers to and from the service provider financial institution 408 are determined according to the methods of the present invention disclosed herein.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. For example, those skilled in the art know how to arrange computers into a network and enable communication among the computers. Additionally, those skilled in the art will realize that the present invention is not limited to paying mortgage payments. For example, the present invention may be applied to car loans, consumer loans, and the like. Accordingly, the above description should not be taken as limiting the scope of the invention, which is defined in the following claims.

What is claimed is:

1. A method of facilitating the repayment of a loan to a creditor, comprising:
receiving a request from a customer to initiate loan acceleration;
on about the last day of a grace period relating to a loan payment of the customer, processing an electronic funds transfer to pay the loan payment;
prior to the end of the grace period, sending information to the creditor that credits the customer for having paid the loan;
debiting a first amount from an account of the customer;
contemporaneously with a payday of the customer, debiting a second amount from an account of the customer, wherein the second amount is debited prior to the end of a subsequent grace period relating to a subsequent loan payment of the loan.

2. The method of claim 1, further comprising:
contemporaneously with later paydays of the customer, debiting additional amounts from one or more accounts of the customer and processing additional electronic funds transfers to pay additional loan payments of the customer, such that at some point, consecutive debits from the one or more accounts of the customer occur without an intervening loan payment.

3. The method of claim 1, further comprising:
contemporaneously with later paydays of the customer, debiting additional amounts from one or more accounts of the customer and processing additional electronic funds transfers to pay additional loan payments of the customer, such that at some point, consecutive electronic funds transfers are processed to pay the customer's loan payment without an intervening debit from an account of the customer.

4. The method of claim 1, wherein an immediately previous loan payment was paid by the customer after a grace period relating to the immediately previous payment.

5. The method of claim 1, wherein the first amount is less than a loan payment of the customer.

6. The method of claim 1, wherein the first amount is approximately 50% of the loan payment.

7. The method of claim 1, wherein the first amount is greater than 50% of the loan payment.

8. The method of claim 1, wherein the customer receives a paycheck on a biweekly schedule.

9. The method of claim 1, wherein the customer receives a paycheck on a weekly schedule.

10. The method of claim 1, wherein the customer receives a paycheck on a semimonthly schedule.

11. The method of claim 1, wherein the customer receives a paycheck on a monthly schedule.

12. The method of claim 1, wherein the loan relates to a mortgage.

13. A system for facilitating the repayment of a loan to a creditor, comprising:
a host computer system programmed to:
process an electronic funds transfer to pay a loan payment of the customer on about the last day of a grace period relating to the loan payment of the customer;
prior to the end of the grace period, send information to the creditor that credits the customer for having paid the loan;
initiate processing of a debit of a first amount from an account of the customer;
contemporaneously with a payday of the customer, initiate processing of a debit of a second amount from an account of the customer, wherein the second amount is debited prior to the end of a subsequent grace period relating to a subsequent loan payment of the loan.

14. The system of claim 13, wherein the host computing system is further programmed to:
contemporaneously with later paydays of the customer, debit additional amounts from one or more accounts of the customer and process additional electronic funds transfers to pay additional loan payments of the customer, such that at some point, consecutive debits from the one or more accounts of the customer occur without an intervening loan payment.

15. The system of claim 13, wherein the host computing system is further programmed to:
contemporaneously with later paydays of the customer, debit additional amounts from one ore more accounts of the customer and process additional electronic funds transfers to pay additional loan payments of the customer, such that at some point, consecutive electronic funds transfers are processed to pay the customer's loan payment without an intervening debit from an account of the customer.

16. The system of claim 13, wherein an immediately previous loan payment was paid by the customer after a grace period relating to the immediately previous payment.

17. The system of claim 13, wherein the first amount is less than a loan payment of the customer.

18. The system of claim 13, wherein the first amount is approximately 50% of the loan payment.

19. The system of claim 13, wherein the first amount is greater than 50% of the loan payment.

20. The system of claim 13, wherein the customer receives a paycheck on a bi-weekly schedule.

21. The system of claim 13, wherein the customer receives a paycheck on a weekly schedule.

22. The system of claim 13, wherein the customer receives a paycheck on a semimonthly schedule.

23. The system of claim 13, wherein the customer receives a paycheck on a monthly schedule.

24. The system of claim 13, wherein the loan relates to a mortgage.
